(19) United States
(12) Patent Application Publication
(10) Pub. No.: US 2010/0132736 A1
(43) Pub. Date: Jun. 3, 2010

(54) Test Cell Conditioner (TCC) Surrogate Cleaning Device

(75) Inventors: Yih-Min LIN, Hsinchu City (TW); Chung-Hsien Yang, Hsinchu City (TW); Alan E. Humphrey, Reno, NV (US); Jerry J. Broz, Longmont, CO (US)

Correspondence Address: HDLS IPR Services, PO Box 220746, Chantilly, VA, 20153, US

(73) Assignees: Jtron Technology Corporation; International Test Solutions, Inc.

(21) Appl. No.: 12/626,734

(22) Filed: Nov. 27, 2009

(30) Foreign Application Priority Data
Dec. 1, 2008 (TW) 097221473
Dec. 25, 2008 (TW) 097223253

(51) Int. Cl. B08B 7/00

(52) U.S. Cl. 134/6; 15/97.1

(57) ABSTRACT

A test cell conditioner (TCC) surrogate cleaning device for cleaning the pin elements in a socket or electrical interface receptacle of a load board includes a main testing frame, a plurality of trays, testing chip receptacles and one or more pick up devices. Chips to be tested (electronic elements) are entrained on a tray, and a plurality of adhesive cleaning chips are entrained on another tray. The adhesive cleaning chip contains a solid layer and an adhesive layer, and an abrasive material is mingled in the adhesive layer. The pick up device removes the adhesive cleaning chip to a position above the testing chip receptacle and cleans up the oxides and other foreign materials sticking on the receptacle by absorption or abrasion. Interrupting the operation of the apparatus to clean the test probe by etching can be excluded so as to improve the working efficiency.

### BACKGROUND OF THE INVENTION

1. Field of the Invention

The invention provides methods for cleaning a load board test socket or an IC device receptacle, and associated pin elements with a test cell conditioner (TCC) cleaning surrogate device applied in a manner similar to that used for performing the handling of a packaged semiconductor device for under actual test conditions.

2. Description of the Prior Art

Keeping in pace with the progress of the computer technology, the devices used in equipment related to the computer have been evolving day after day. The use of the same type memory chip mode will not last long while the demand to upgrade the quality thereof is growing more and more strict.

The fabrication process of a semiconductor device generally includes layer stacking, patterning, doping, and heat treatment, after that the steps of testing the chip sliced from the wafer, packaging and assembling are to follow.

The semiconductor device includes a plurality of pads, which is conductive and electrically connecting with specially designed circuit scheme. In testing chips, a pad testing item shall not be omitted so as to make sure it can work normally. In testing chips supplied by different manufactures, a different testing apparatuses are required to test chips with different pin position and sizes, therefore various molds have to be prepared to carry out the testing, in such a case, a multi-pointed probe array is utilized for testing various kinds of IC chips resulting in wasting cost and time of the manufacturers.

In the conventional IC chip testing technology, the test probe is brought in contact with the chip pad before performing the test procedure. If the probe point is etched before testing, malfunction of the testing can be eliminated so that the damage to the IC chip is avoided. The probe point is etched and cleaned before testing, but the testing operation will be too tedious to perform the work efficiently.

In view of the foregoing situation, the inventor of the invention herein went to great lengths of intensive research based on many years of experience gained through the professional engagement in the study of related products, with continuous experimentation and improvement culminating in the development of the present invention.

### SUMMARY OF THE INVENTION

It is an object of the present invention to provide a test cell conditioner (TCC) surrogate cleaning device for cleaning the pin elements in a socket or electrical interface receptacle of a load board which can effectively clean the probe point for testing the IC chip.

It is another object of the present invention to provide a test cell conditioner (TCC) surrogate cleaning device for cleaning the pin elements in a socket or electrical interface receptacle of a load board which can improve reliability of the products, prolong the apparatus lifespan, save the installation space for the apparatus so as to lower the production cost.

To achieve the aforesaid objects, the test cell conditioner (TCC) surrogate cleaning device for cleaning the pin elements in a socket or electrical interface receptacle of a load board has a main testing frame including a plurality of various trays, a testing chip receptacle and one or more pick up devices. A plurality of chips to be tested are put on a tray, and a plurality of adhesive cleaning chips are settled in another tray. The adhesive cleaning chip has a solid layer and an adhesive layer. The pick up device remove the adhesive cleaning chip to the testing chip receptacle and clean up the oxides, dust or other foreign granules which may affect the test results away from the receptacle by adhesion.

In the present invention, the adhesive material, instead of etchant, is used to clean the probe point so as to make a better contact between the probe and the IC chip, and need not to interrupt the operation to clean the probe point, but only to adhere those foreign materials with the adhesive layer of the cleaning chip so as to improve the efficiency of cleaning.

In the present invention, the adhesive layer of the cleaning chip is formed of a porous surface to ensure an effective contact with that of the probe so as to clean the oxide, dust or other foreign materials from the receptacle.

In the present invention, the adhesive layer is mingled with the diamond burrs so as to enhance the friction of the probe surface

### BRIEF DESCRIPTION OF THE DRAWINGS

FIG. 1 is a schematic view of the main testing frame of the present invention.

FIG. 2A is an illustrative view showing the operation of the adhesive cleaning chip according to the present invention.

FIG. 2B is an illustrative view showing the function of the porous surface of the adhesive cleaning chip according to the present invention.

FIG. 3A through FIG. 3C are illustrative views showing the operation of the adhesive apparatus for cleaning testing chip receptacle in an embodiment of the present invention.

FIG. 4A through FIG. 4C are illustrative views showing how the porous surface of the adhesive cleaning chip perform its mission in an embodiment of the present invention.

### DETAILED DESCRIPTION OF THE PREFERRED EMBODIMENTS

The invention provides methods for cleaning a load board test socket or an IC device receptacle, and associated pin elements with a test cell conditioner (TCC) cleaning surrogate device applied in a manner similar to that used for performing the handling of a packaged semiconductor device for under actual test conditions. A preferred embodiment of a test cell conditioning (TCC) cleaning surrogate device may be used in the implementation of the method.

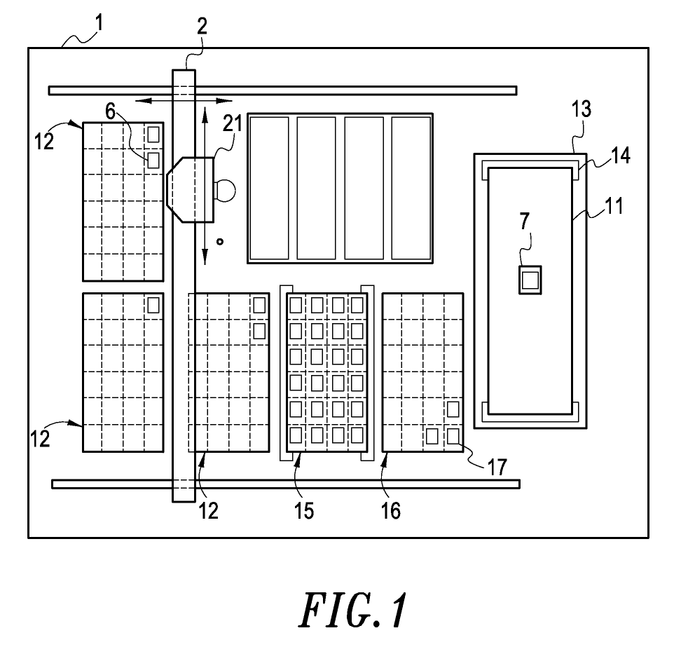

The test cell conditioning (TCC) cleaning surrogate device and apparatus of the present invention comprises following component parts within automated test equipment (FIG. 1):
A main testing frame 1 that houses a plurality of custom trays or JEDEC device trays 12, 13, 15, 16, and load board 11, test socket or chip testing receptacle 7.
One or more pick up and place devices 2.
A plurality of electronic IC devices or IC device packages 6 that are housed within various device trays or JEDEC standard trays 12, 13, 15, 16.
A plurality of a test cell conditioner (TCC) cleaning surrogate devices 17 that are housed in another tray or interspersed within a device tray device trays or JEDEC standard trays 12, 13, 15, 16.

As shown in FIG. 1, the apparatus comprises a main testing frame 1 and a plurality of pick up devices 2. In the main testing frame 1, there is a waiting tray 12 on which electronic elements 6 (for example, integrated circuit devices waiting to be tested) are loaded. At a side of the main testing frame 1, there is a testing tray 13 which contains a plurality of accommodation cells 14 for laying a plurality of load board 11. There is a post test tray 15 provided at another side of the testing tray 13. The test board 11 may be an ordinary main board or other peripheral circuit board (card) of a desk computer, note-book computer, PDA, main frame for a micro computer or a bulk computer, electrical equipment or the like which is settled in the accommodation cell 14 of the main testing frame 1. Besides, there is a rest tray 16 for entraining the a test cell conditioner (TCC) cleaning surrogate device 17 which is to clean the testing chip receptacle 7 provided in the test load board 11 on the testing tray 13. The pick up device 2 is an automation machine which can automatically perform the action of picking up, settling, interposing and pulling out the electronic device 6 and the test cell conditioner (TCC) cleaning surrogate device 17. Such an automation machine can be a track way guided machine arm or mechanical elbow or other like machinery whose action can be controlled by an automatic command. The pick up device 2 can be respectively disposed above the main testing frame 1 among the waiting tray 12, testing tray 13, rest tray 16 and post test tray 15. There is at least one pick up head 21 to put/take the electronic element 6 into/out of the test board 11. The pick up head 21 may be an imbibing head or a gripping head for imbibing/gripping the chip. The test cell conditioner (TCC) cleaning surrogate device 17 is entrained on a tray alone, or the test cell conditioner (TCC) cleaning surrogate device 17 and the electronic element 6 are entrained on the same tray.

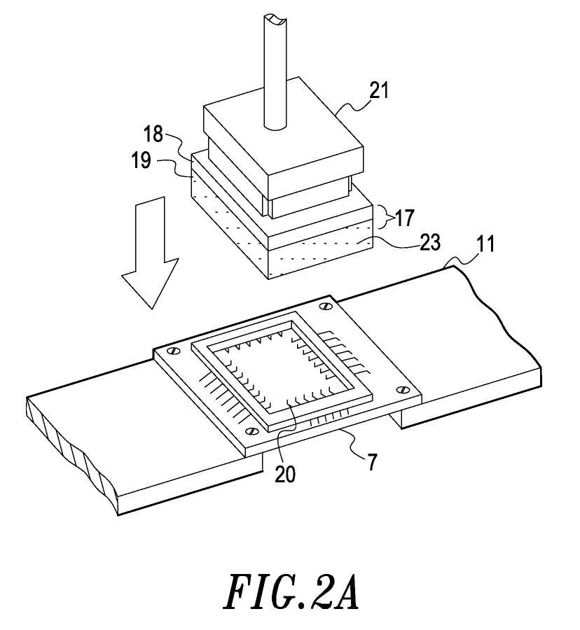

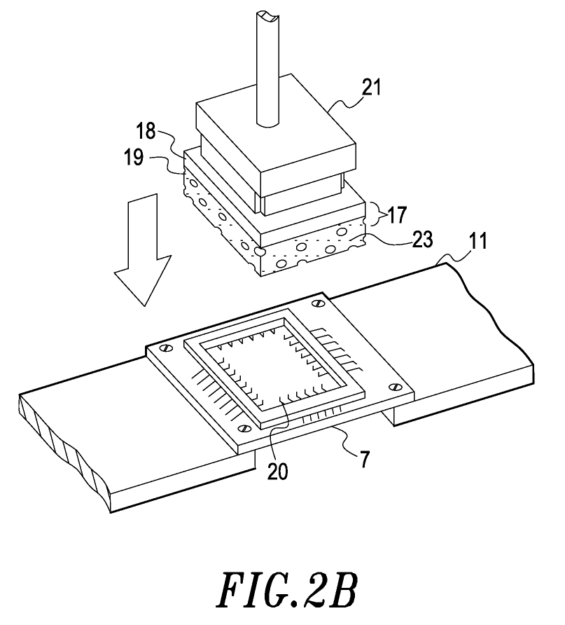

Referring to FIG. 1, FIG. 2A and FIG. 2B, if the testing chip receptacle 7 in the test board 11 on the testing tray 13 is to be cleaned, the pick up device 2 entrained on the rest tray 16 picks up the a test cell conditioner (TCC) cleaning surrogate device 17 with the pick up head 21, and removes the pick up device 2 to a position above the testing chip receptacle 7 in the test board 11 entrained on the testing tray 13, and then continues the operation of putting/taking the a test cell conditioner (TCC) cleaning surrogate device 17 into/out of the test board 11.

In FIGS. 2A and 2B, preferred embodiments of the test cell conditioner (TCC) surrogate cleaning device 17 is shown. It should be understood that the exact configuration of the substrate and cleaning media material shown in the representative embodiments depicted herein may be departed from so long as their functions are maintained within the scope of the invention as described.

The TCC cleaning device body 18 consists of a rigid substrate, a dummy package, or a device package that approximates the dimensions of the packaged IC device and a cleaning media layer 23. The cleaning media 23 is elastic in general texture, and has an adhesive surface for debris collection and abrasive properties for contact pin polishing, and can include multiple layers (FIG. 2A). The elastomeric material cleaning can also be comprised of one or more small, large, or closed cell sponge-like materials (FIG. 2B).

The overall size of the TCC 17 matches the actual device XYZ tolerances such that the pick-up device 21 can load and unload the TCC 17 without any adjustments. Insertion of the TCC 17 is performed into the tester board 7 such that contact is made with all contact pins 20 (FIG. 2B). It is preferable for all of the contact pins 20. e.g., pogo pins, spring pins, sliding electrical contacts, or other contact elements, to come into physical contact with the cleaning media 23. In one preferred embodiment of the invention, the cleaning media 23 is exactly the same size as body (FIGS. 2A and 2B) to sufficiently engage pin elements, vertical contactors, or any sliding contactors along the periphery of the package as well as the bottom surface of the socket. In another preferred embodiment of the invention, the cleaning media 23 surface is slightly smaller in the XY dimensions than the TCC cleaning device body 18, yet is sufficiently large to engage the entire upper surface of the contactor body and each of contact pins 20. Presently, the preferred cleaning media 23 is a tacky, elastomeric material layer or film with controlled abrasive properties and material characteristics that is affixed to the TCC cleaning device body 18 using a suitable adhesive layer. The cleaning material layer 23 is provided for the purpose of accepting the insertion of the socket contact pins 20, thereby capturing contaminants 22 and retaining them subsequent to the withdrawal from the socket. The spatially distributed abrasive particles within the cleaning material serve the purpose of polishing the pin element contact surfaces. It should be understood that the exact configuration of the substrate and cleaning media material shown in the representative embodiments depicted herein may be departed from so long as their functions are maintained within the scope of the invention as described. In implementing the presently preferred embodiment of the invention the cleaning material media used is commercially available from International Test Solutions, Reno, Nev., USA.

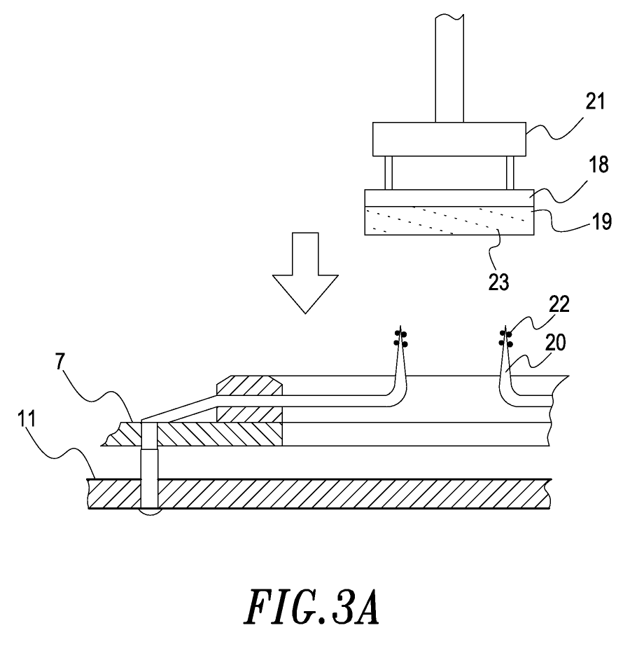

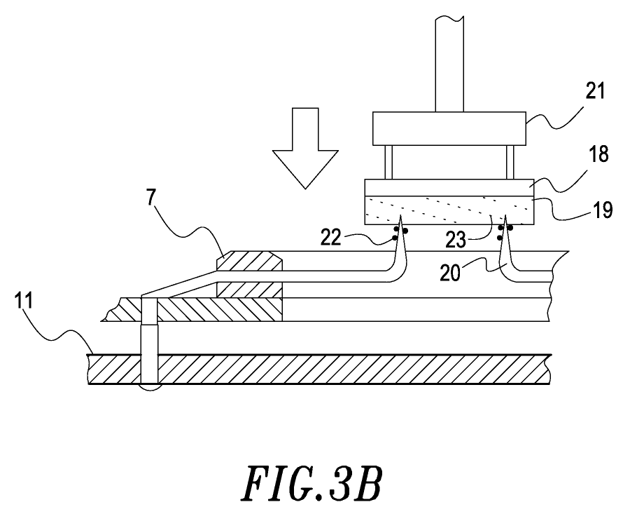

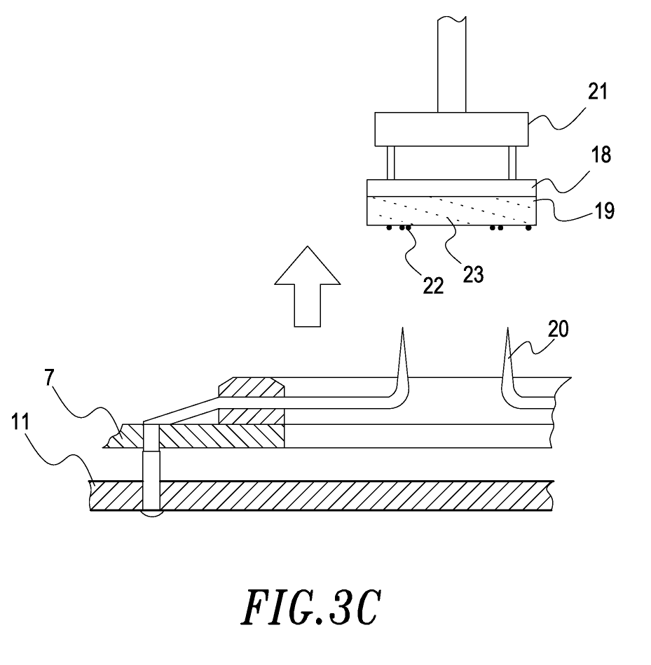

Referring to FIG. 3A through FIG. 3C, the pick up device 2 moves the test cell conditioner (TCC) cleaning surrogate device 17 to a position above the testing chip socket or receptacle 7 and eliminate the oxides, dust or other foreign granules 22 which may affect the test results away from the testing chip receptacle 7 by adhesion or friction or abrasion. It can be seen that in using the preferred embodiment of the invention shown, the contact pins 20 penetrate make contact with the working surface of the cleaning material layer 23 and at least partially into the thickness of the elastomeric layer 23. Abrasive particles that may include and are not limited to aluminum oxide, silicon carbide, and diamond are incorporated into and spatially distributed either uniformly or preferentially within or across the working surface one or more of the pad layers

Referring to FIG. 3A through FIG. 3C, the test cell conditioner (TCC) cleaning surrogate device 17 can be composed of a solid layer 18 having a certain degree of hardness for withstanding the force applied by the head 21 of the pick up device 2, and an adhesive layer 19.

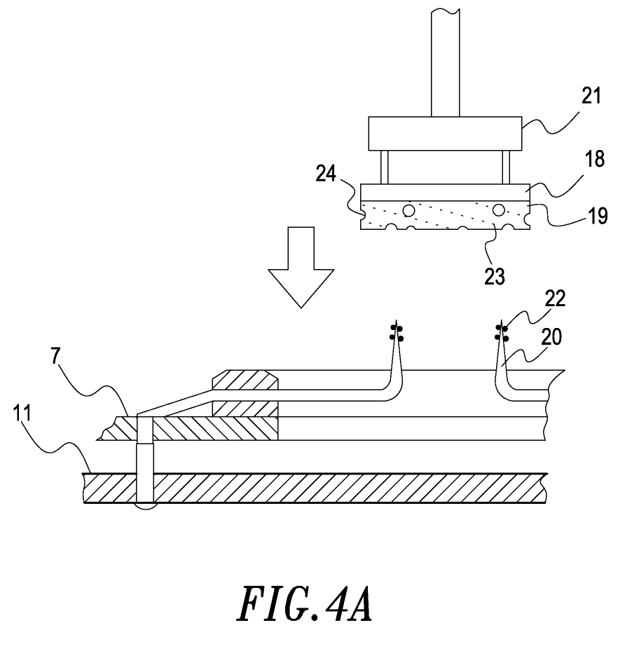

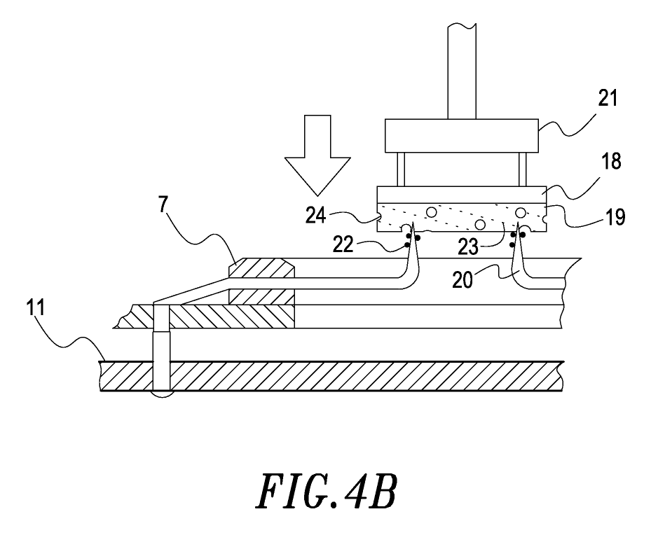

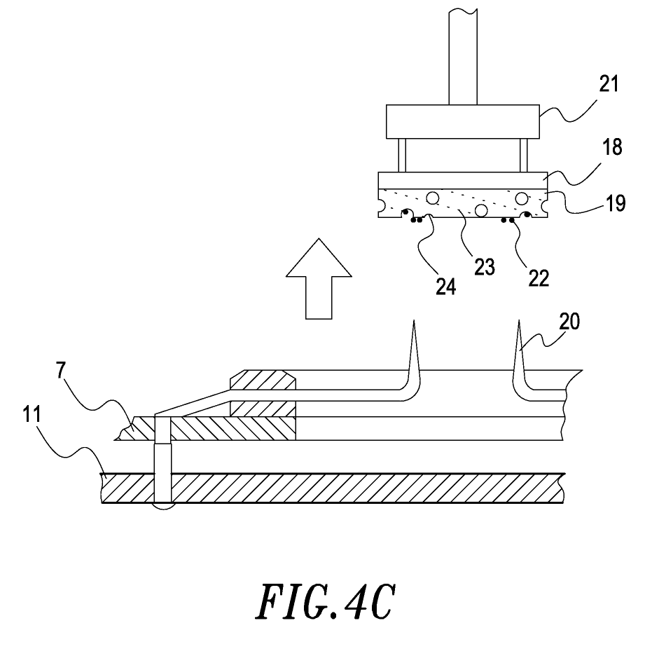

Referring to FIG. 4A through FIG. 4C, test cell conditioner (TCC) cleaning surrogate device 17 can be composed of a porous layer 23 formed around the adhesive layer 19 to increase the contact surface with the test probe 20 and adhere the oxides, dust or other granules 22 which may affect the test result with the pores 23 so as to achieve the aim of effectively cleaning the test probe 20. This layer may be constructed in one or multiple material layers of solid, or porous adhesive and abrasive properties, or some combination of materials. The pick up device 2 is removed to a position above the testing chip receptacle 7 in the test board 11 entrained on the testing tray 13 to perform operation of putting/taking the test cell conditioner (TCC) cleaning surrogate device 17 into/out of the test board 11, and the adhesive layer 19 directly contacts the test probe 20 provided on the testing chip receptacle 7 so as to clean and eliminate the oxides, dust or other granules 22 which may affect the test results by adhesion or abrading the surface of the test probe 20 with abrasive particles 24 that may include and are not limited to aluminum oxide, silicon carbide, and diamond are incorporated into and spatially distributed either uniformly or preferentially within one or more of the pad layers

Solid layer 18 and adhesive layer 19 may configured into various shapes to meet the need of different kinds of testing chip receptacles 7 and trays to be cleaned. For example, in case of cleaning ball grid arrayed (BGA) testing chip receptacles 7 on the test board 11 with test cell conditioner (TCC) cleaning surrogate device 17, the shape of the adhesive layer 19 may configured to meet the BGA configuration that disposes the metal alloy balls on the grid protuberances so as to facilitate cleaning the oxides, dust and other granules 22 which may affect the test results. Actually a BGA is one kind of package of surface mounted synthetic electronic circuit (the structure of IC circuit is practically a “packed” or “surface mounted” semiconductor printed circuit board), and a BGA package seems a thin wafer semiconductor material with only one face on the circuit. Basically BGA is an array of disposing the metal alloy balls to form a grid, and many Sn balls are disposed in an array at the bottom of a chip, and replacing the conventional surrounding lead pins with the Sn balls. The test cell conditioner (TCC) cleaning surrogate device 17 is also can be used clean the testing chip receptacles 7 of a TQFP thin flat square package laid on the test board 11. Since the TQFP has different types of pins, the adhesive layer 19 can be designed to have various shapes to match the different pad areas so as to eliminate the oxides, dust and granules 22 that may affect the test results by adhesion. Similarly, all other packages such as LGA, CSP, QFP, QFN, PLCC, TSOP, DIP, SOP, Flip-chip or MCM can be cleaned by adjusting the configuration of the solid layer 18 or the adhesive layer 19.

In brief, it emerges from the description of the above embodiment that the invention has several noteworthy advantages, in particular:
1. Material properties, such as hardness, tack, compliance, compressibility, and surface geometries of the cleaning material layer serves to increase the contact area between the test cell conditioner (TCC) cleaning surrogate device and the test probe to improve the overall cleaning and debris collection effectiveness.
2. Abrasive particles that may include and are not limited to aluminum oxide, silicon carbide, and diamond are spatially distributed either uniformly or preferentially within or across the working surface of the one or more of the cleaning material layers will polish the contact elements without damaging the probe point.
3. The combination of debris collection from the contact elements and the socket interior combined with pin element polishing improve the cleaning efficiency and make it unnecessary to stop operation of the apparatus and testing process to clean the contact elements and socket interior.
4. The reliability of the products is improved, the test apparatus and socket lifespan is prolonged, the need for additional and redundant testing is eliminated and the need for additional test hardware is reduced to result in lowering the production cost.
5. It is not necessary to adjust the hardware structure of the main testing frame to implement an IC chip provided with a cleaning material layer so that the overall working efficiency is increased.
6. Those skilled in the art will appreciate that the specific embodiment disclosed in the foregoing description may be readily utilized as a basis for modifying or designing other embodiments for carrying out the same purposes of the present invention. Those skilled in the art will also appreciate that such equivalent embodiments do not depart from the spirit and scope of the invention as set forth in the appended claims.

What is claimed is:

1. A test cell conditioner (TCC) surrogate cleaning device for cleaning pin elements in a socket or electrical interface receptacle of a load board used in semiconductor device testing with test equipment and associated handlers, the cleaning device comprising:
a substrate with a configuration that can be introduced into the socket or electrical interface receptacle during normal operations, wherein the substrate body approximates the semiconductor device configuration; and
a. a cleaning pad comprised of one or more layers, secured to the substrate, that has predetermined characteristics that cause the pad to polish and scrub the pin elements as well as clean and collect debris, thereby removing contamination and residuals from the pin elements and the socket surfaces as the pad makes contact with pin elements and socket surfaces such that the pin elements and socket surfaces are cleaned, without modification or damage, during normal operation.

2. The cleaning device of claim 1, wherein the pad layers have predetermined geometric, abrasive, roughness, durometer, tack, and elasticity characteristics.

3. The cleaning device of claim 1, wherein the pad comprises a tacky material so that debris adheres to the pad when the pin elements and socket surfaces contact the pad.

4. The cleaning device of claim 1, wherein the pad traps hazardous material, on and within the pad when the probe elements are inserted into the pad.

5. The cleaning device of claim 1, wherein the pad comprises an elastomeric material that traps and removes the debris from the pin elements and socket surfaces within and on the surface of the pad.

6. The cleaning device of claim 5, wherein the elastomeric material is comprised one or more of rubbers, synthetic polymers, synthetic foams, and natural polymers.

7. The cleaning device of claim 5, wherein the elastomeric material is comprised one or more small, large, or closed cell sponge-like materials.

8. The cleaning device of claim 5, wherein abrasive particles that include aluminum oxide, silicon carbide, and diamond are incorporated into and spatially distributed either uniformly or preferentially within the pad layers.

9. The cleaning device of claim 5, wherein abrasive particles that include aluminum oxide, silicon carbide, and diamond are uniformly or preferentially distributed across the surface of the pad layers.

10. A method for cleaning the pin elements in a socket or an electrical interface receptacle of a load board used in semiconductor device testing with test equipment and associated handlers, the method comprising:
a. loading a test cell conditioner cleaning device into the socket or electrical interface receptacle, the cleaning device having the same configuration as IC devices normally tested by apparatus, the cleaning device having a top surface with predetermined properties that clean the pin elements and interior of the test socket;
b. contacting the pin elements with the cleaning device during normal operations to remove debris from the pin elements, the cleaning device having one or more layers that clean the pin elements and collect debris removed from the pin elements so that the probe elements are cleaned.

11. The method of claim 10, wherein the loading of the test cell conditioner (TCC) surrogate cleaning device further comprises periodically handling a cleaning tray containing one or more cleaning devices into the testing machine when the probe elements need to be cleaned.

12. The method of claim 10, wherein the loading of the test cell conditioner (TCC) surrogate cleaning device further comprises handling one or more cleaning devices within one or more JEDEC trays along with IC devices being tested so that the cleaning devices are contacted during the testing process of the IC devices.

13. The method of claim 9, wherein the test socket remains in a cleaned state for a longer period of time increases yield performance increases an amount of revenue for the manufacturer.

14. The method of claim 10, wherein the test cell conditioner (TCC) surrogate cleaning device is able to prolong the life of the test socket and reduce the number of test sockets the manufacturer is required to purchase in order to have spares.

15. The method of claim 10, wherein the cleaning material properties, such as density, geometry, and abrasiveness, can be defined for any given pin element material or contactor shape to remove embedded or bonded debris without significant damage to the pin element or the socket.
